(19) United States
(12) Patent Application Publication
(10) Pub. No.: US 2005/0264585 A1
(43) Pub. Date: Dec. 1, 2005

(54) Visual display transformation

(76) Inventor: Michael G. Trombley, St. Louis Park, MN (US)

Correspondence Address: Kirk Cesari;Seagate Technology LLC, Intellectual Property - SHK2LG, 1280 Disc Drive, Shakopee, MN, 55379, US

(21) Appl. No.: 10/854,302

(22) Filed: May 26, 2004

(51) Int. Cl. G01S 13/00; G09G 5/00

(52) U.S. Cl. 345/647

(57) ABSTRACT

A visual display system includes a buffer that receives and stores first coordinates of locations of anomalies on a surface. Some of the locations occur in out-of-round patterns including deviations from round. A processor receives the first coordinates and that transforms the first coordinates to second coordinates. Deviations from round in the first coordinates are transformed to deviations from straight lines in the second coordinates. A visual display unit generates a visual display of the second coordinates in a cartesian bitmap portion of the visual display.

### FIELD OF THE INVENTION

The present invention relates generally to transformation of data for visual display, and more particularly but not by limitation to transformation of polar magnetic storage media anomaly data for cartesian display.

### BACKGROUND OF THE INVENTION

Data representing flaws, irregularities or anomalies of various kinds are frequently displayed on a video display so that a technician can recognize repetitive characteristic patterns in the data that indicate a potential source of the flaw, irregularity or anomaly. When the data is scanned in a polar format, and the characteristic patterns are small deviations from exact roundness, then it is particularly difficult for the human eye to recognize the characteristic patterns, even when reference guide lines in the form of concentric circles are superimposed on the display of the data.

A method and apparatus are needed that will overcome the problem in recognizing small deviations from roundness in a polar data pattern on a video display. Embodiments of the present invention provide solutions to these and other problems, and offer other advantages over the prior art.

### SUMMARY OF THE INVENTION

Disclosed is a visual display system. The visual display system comprises a buffer that receives and stores first coordinates of locations of anomalies on a surface.

The visual display system comprises a processor. The processor receives the first coordinates from the buffer and transforms the first coordinates to second coordinates. Deviations from round in the first coordinates are transformed to deviations from straight lines in the second coordinates.

The visual display system comprises a visual display unit coupled to the processor. The visual display generates a visual display of the second coordinates in a cartesian bitmap portion of the visual display.

Other features and benefits that characterize embodiments of the present invention will be apparent upon reading the following detailed description and review of the associated drawings.

### BRIEF DESCRIPTION OF THE DRAWINGS

FIG. 1 illustrates an isometric view of a disc drive.

FIG. 2 illustrates an anomaly data table and a polar display of the data table.

FIG. 3 illustrates an enlarged view of a visual display of anomalies on a pixellated visual display unit.

FIG. 4. illustrates an embodiment of a visual display system that transforms first coordinates to second coordinates.

FIG. 5 illustrates a visual display of a cartesian bitmap of anomalies in second (transformed) coordinates.

FIG. 6 illustrates an embodiment of a method of visual display transformation.

### DETAILED DESCRIPTION OF ILLUSTRATIVE EMBODIMENTS

In the embodiments described below, anomaly data obtained by polar scanning is transformed to a cartesian XY display and displayed on a visual display unit such as a video display. Patterns of anomalies that deviate slightly from perfectly round are difficult to recognize in a display of the data in polar form. This same data, however, when transformed to a cartesian display, reveals the deviations as easily recognized wave shapes that deviate from straight reference lines. Patterns of anomalies can be recognized, and the source or cause of the anomalies in the pattern can be inferred from the pattern. Troubleshooting of anomalies found on a surface is facilitated.

In one example, discs in disc drives are scanned for defects (anomalies) on a storage media surface. The scanning includes writing patterned data to the disc, then reading the patterned data back from the disc and comparing the readback data to the original pattern that was written. When data read back doesn't match the pattern written, the cylinder (radius) and position (angle) of each data anomaly is recorded in an anomaly table. Preferably, only hard errors, and not soft errors, are included in the anomaly table. When the anomaly table is displayed in its polar form, it is difficult to recognize patterns that deviate only slightly from a circle. The patterns found when viewing the same data in transformed cartesian coordinates, however, tends to reveal the patterns and indicate the source or cause of the individual or groups of anomalies.

In one example, these anomalies are generated by the manufacturing tools used (often associated with the “texturing” or “roughing-up” process on the disc surface). Texturing based anomalies are recognized when the anomaly pattern follows the path of the tools used during the preparation of the disc. It is these patterns that, when plotted on polar based plots, often appear as nearly concentric arcs that can be difficult to resolve on the polar plots, but more readily present themselves on transformed cartesian plots.

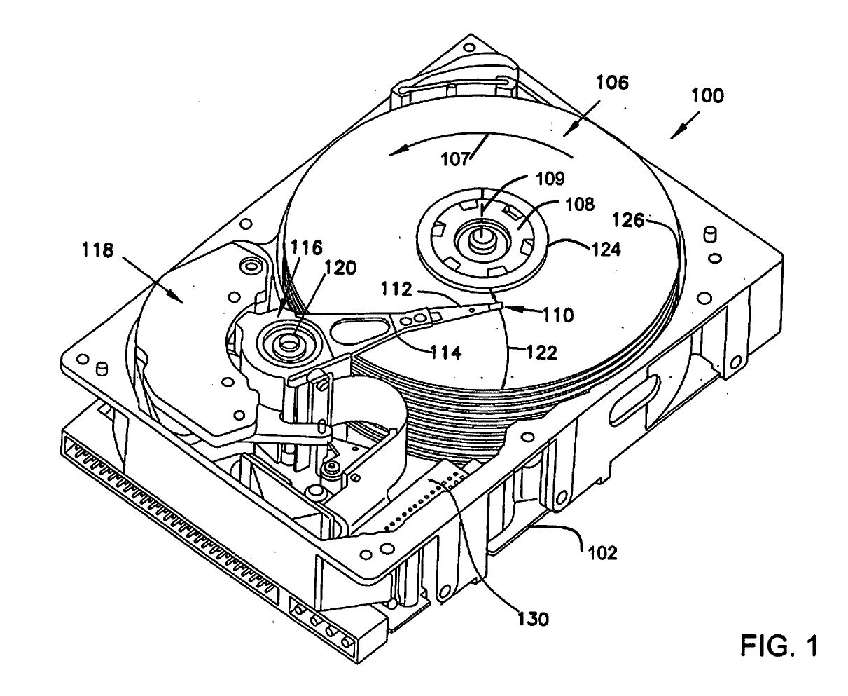

FIG. 1 is an isometric view of a disc drive 100 in which embodiments of the present invention are useful. Disc drive 100 includes a housing with a base 102 and a top cover (not shown). Disc drive 100 further includes a disc pack 106, which is mounted on a spindle motor (not shown) by a disc clamp 108. Disc pack 106 includes a plurality of individual discs, which are mounted for co-rotation about central axis 109 in a direction indicated by arrow 107. Each disc surface has an associated disc head slider 110 which is mounted to disc drive 100 for communication with the disc surface. In the example shown in FIG. 1, sliders 110 are supported by suspensions 112 which are in turn attached to track accessing arms 114 of an actuator 116. The actuator shown in FIG. 1 is of the type known as a rotary moving coil actuator and includes a voice coil motor (VCM), shown generally at 118. Voice coil motor 118 rotates actuator 116 with its attached heads 110 about a pivot shaft 120 to position heads 110 over a desired data track along an arcuate path 122 between a disc inner diameter 124 and a disc outer diameter 126. Voice coil motor 118 is driven by servo electronics 130 based on signals generated by heads 110 and a host computer (not shown). When the disc surface is tested for anomalies (errors), the read/write heads 110 scan a large number of concentric tracks on the disc surface. A processor (not illustrated in FIG. 1) generates a table of anomalies that are organized in polar coordinates (radius, angle) that correspond with the shape of the concentric tracks on the annular media surface. The entire disc may scanned, or portions of the disc may be sampled to generate the table of anomalies.

In addition to storage media surfaces, the transformation apparatus and methods described below can also be used on a variety of other two or three dimensional surfaces that are scanned to produce data arranged in polar coordinates. These scanning methods include magnetic, radar, sonar, optical, electromagnetic, x-ray and tomography scanning applications.

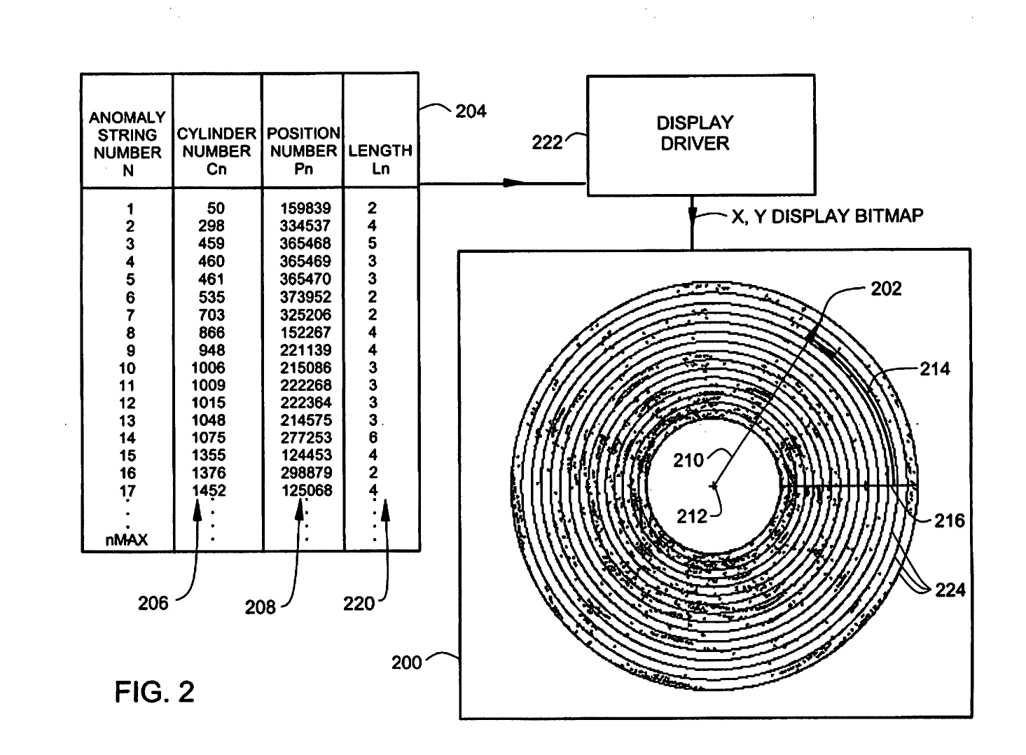

FIG. 2 illustrates a polar video display 200 of a large number of anomalies (such as anomaly 202) on a surface. Each anomaly is represent by a dot in the polar video display 200. A rotary scanning process generates an anomaly list 204 of first coordinates 206, 208 of the anomalies in a generally polar first coordinate system C, P. The generally polar coordinate system may not be a simple polar coordinate system (radius, angle) but may include extraneous formatting associated with a data processing system (not illustrated). The generally polar coordinate system includes a coordinate that corresponds generally with a radius 210 relative a central scanning pivot 212 (such as axis 109 in FIG. 1, for example) and a coordinate that corresponds generally with a scanning angle 214 relative to an index or reference line 216 (such as line 122 in FIG. 1, for example). The reference line 216 can be straight or slightly curved depending on the manner in which the data is scanned. The generally polar system can also include a third axis (not illustrated) and define positions of anomalies according to a generally cylindrical coordinate system. The scanning can be accomplished using mechanical motion (as illustrated in FIG. 1 for example) or scanning can also be accomplished by phase angle changes (such as with phase-controlled directional radar antenna arrays, for example).

In one preferred arrangement, the generally polar coordinate system comprises cylinder numbers Cn (that generally defines a radius coordinate of an anomaly) and position numbers Pn (that generally defines an angular coordinate of the anomaly). In a further preferred arrangement, the coordinate system further comprises a string length 220 (that generally defines a length Ln of a string of sequential adjacent anomalies with increasing position numbers relative to a first anomaly at the position number Pn). The use of string numbers tends to compress a table length Nmax of the anomaly table 204 for faster data handling.

The polar video display 200 can be presented on a video display unit that has a rotational video scanning pattern, such as a rotary scanned sonar or radar CRT display. For such rotational video scanned displays, a display driver 222 can simply scale and provide radius and angle data to the display without a need for complex conversion. Alternatively, the polar video display can be presented on a video display that is XY scanned (such as standard NTSC or PAL displays commonly used with television CRT displays, or a solid state LED or liquid crystal displays commonly used with computers and televisions). For such XY scanned displays, radius R and angle theta information obtained from the anomaly table 204 can be converted to the XY display format by a more complex conversion such as X=R cosine theta, Y=R sine theta. With both types of displays, concentric reference lines 224 are also displayed on display 200, typically in a brightness or color that differs from the brightness or color of the anomalies. It will be understood by those skilled in the art that even though the video display unit itself may be XY scanned, the anomaly data is still displayed in a polar format on the display 200 and is not transformed to an XY format. On display 200, the image of the anomalies is annular like the surface that was scanned; the image is not rectangular.

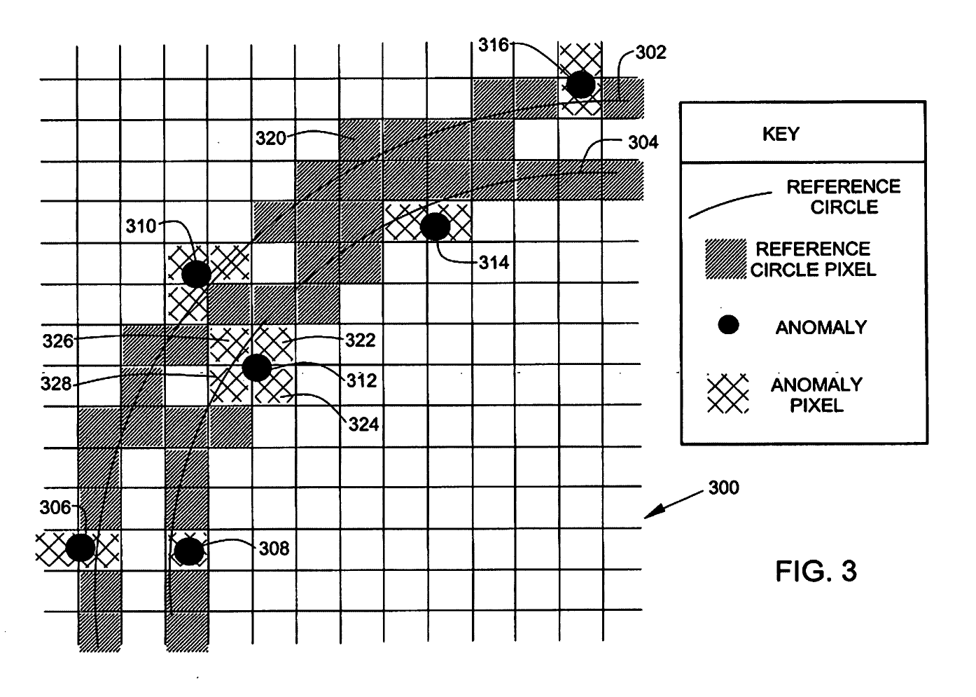

There are a large number of anomalies, such as anomaly 202, and the anomalies are displayed on display 200 so that an operator can observe and attempt to recognize patterns in the anomalies 202. In particular, patterns that tend be repetitive are of interest because the wavelengths of such patterns tend to indicate the source of the anomalies or the manner in which the anomalies were generated. The concentric reference lines 224 serve as a visual aid to help in identifying very small deviations from roundness in anomaly patterns. It is found, however, that it is difficult for an operator to recognize patterns of small deviations from roundness in displays that are polar, even with the aid of concentric reference lines 224. As described below in connection with FIG. 3, this difficulty in recognizing patterns is exacerbated when the display comprises is pixellated or, in other words, comprises discrete pixels.

FIG. 3 illustrates an enlarged view of a small portion of a visual display (such as display 200) that displays anomalies and concentric reference lines. FIG. 3 is not to scale, but has exaggerated dimensions to better illustrate the increased difficulty when a display comprises discrete display pixels. A cartesian grid 300 of generally square pixels is shown. Calculated reference lines 302 and 304 are illustrated, but are not part of the display. Calculated anomaly coordinates 306, 308, 310, 312, 314, 316 are shown, however, these anomaly coordinates are not part of the display. Individual, discrete pixels are activated to display the reference lines 302, 304 and the anomaly coordinates. Pixels (such as pixel 320) that are marked with diagonal lines are activated at a first level (color or brightness) to represent the reference lines 302, 304.

The pixels 300 are in a rectangular grid, and the reference lines 302, 304 are curved, so the patterns of pixels activated to represent the reference lines tend to be somewhat jagged and irregular. The pixels are in a regular grid and the anomaly coordinates in general are not centered over one pixel, but tend to be scattered randomly off-center with respect to the pixel centers. In order to represent an anomaly with off-center coordinates, more than one pixel may be activated to best represent the location of the anomaly. For example, anomaly 312 is represented by activation of four pixels 322, 324, 326, 328. As can be seen in FIG. 3, the pixellation of the display adds a kind of visual “noise” to the display which makes it more difficult to identify regular patterns in the anomalies. Even more difficulty may be encountered with pixellation when the display is a color display and there are separate pixels for each of three colors such as red, green and blue.

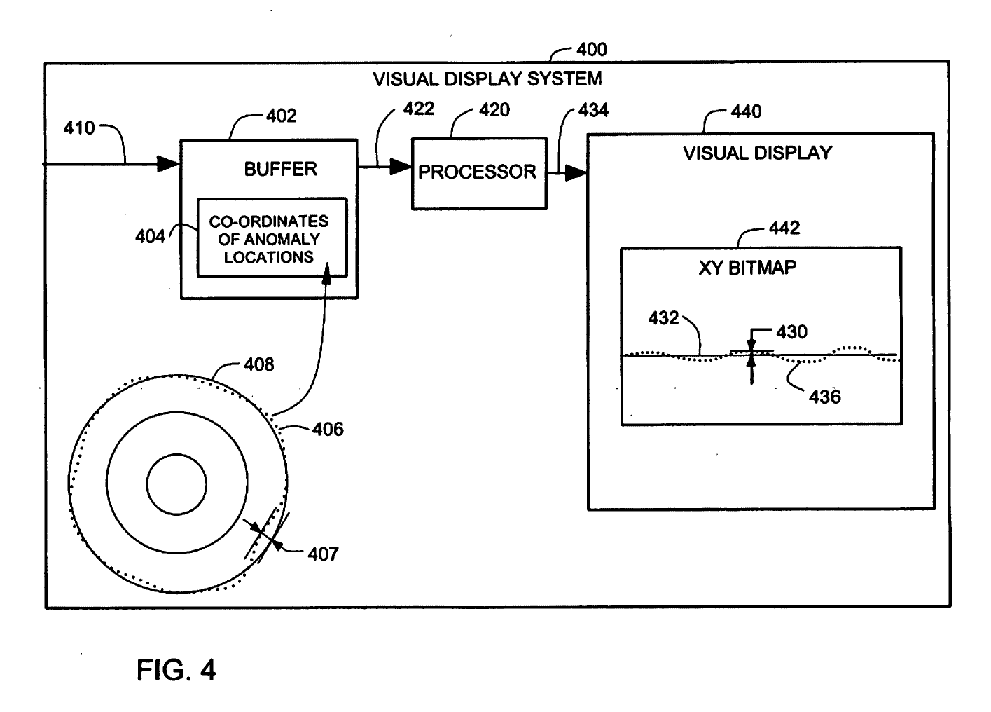

The problems illustrated in FIGS. 2-3 can arise in a wide variety of polar surface scanning applications, such as x-ray or other tomography, radar, sonar, magnetic and electromagnetic surveys, optical systems and other two and three dimensional surface scanning systems. The problems with recognizing pattern described in connection with FIGS. 2-3 can be improved by arrangements and methods described below in examples illustrated in FIGS. 4-6.

FIG. 4. illustrates an embodiment of a visual display system 400 that transforms first coordinates to second coordinates. The visual display system 400 comprises a buffer 402 that receives and stores first coordinates 404 of locations of anomalies on a surface (not illustrated in FIG. 4). Some of the locations can occur in out-of-round patterns 406 that include deviations 407 from a round reference circle 408. Nearly concentric anomalies are difficult to visually resolve. A polar-based representation hides anomaly sets that appear as nearly concentric arcs. In a preferred embodiment, the first coordinates 404 are in the form of an anomaly data table such as anomaly table 205 described above in connection with FIG. 2. The anomaly data table is received on line 410 from a scanning system (not illustrated in FIG. 4) that scans a surface for anomalies or defects.

The visual display system 400 comprises a processor 420. The processor 420 receives the first coordinates 404 on line 422 from the buffer 402. The processor 420 transforms the first generally polar coordinates 404 to second cartesian (XY) coordinates. The deviations 407 from round in the first coordinates 404 are transformed to deviations 430 from straight lines 432 in the second cartesian (XY) coordinates. The processor 420 comprises means for receiving the first coordinates 404 from the buffer and for transforming the first coordinates 404 to second coordinates 436 in the cartesian bitmap such that any deviations from round in the first coordinates are transformed to deviations from straight lines in the second coordinates.

The visual display system 400 comprises a visual display unit 440 coupled along line 434 to the processor 420. The visual display unit 440 generates a visual display 442 of the second coordinates in a cartesian bitmap. The deviations 407 from round are transformed into deviations 430 from the straight line 432 that comprise waves along the straight line in the cartesian bitmap.

In one preferred arrangement, the first coordinates 404 comprise cylinder numbers and position numbers. In a further preferred embodiment, the first coordinates also include string lengths.

The processor 420 is typically a microprocessor system that includes a cartesian display bitmap generator. The processor 420 preferably generates reference straight lines in the cartesian bitmap portion of the visual display.

The scanning system that generates the polar coordinates of anomalies can be a tomographic scanning system, a radar scanning system, a sonar scanning system, a magnetic scanning system, or an optical scanning system. The anomalies can comprise defects on a storage media surface. The storage media surface can comprise magnetic media as illustrated in FIG. 1, or can comprise optical media.

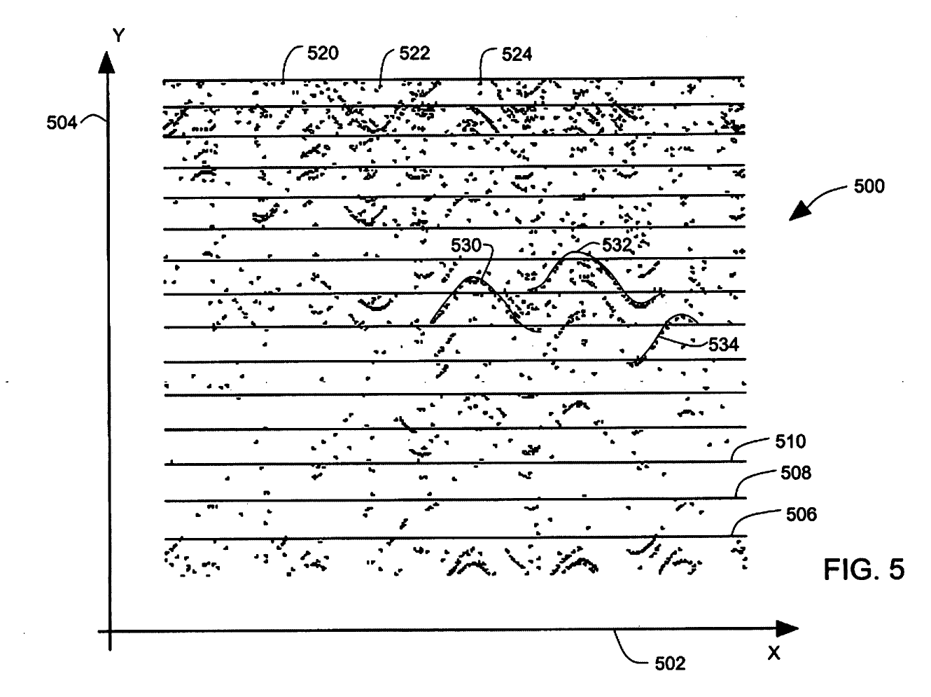

FIG. 5 illustrates a visual display 500 of a cartesian bitmap of anomalies in transformed coordinates. The visual display 500 comprises an X axis 502 and a Y axis 504. The X and Y axes are orthogonal to one another and form a 2 dimensional cartesian coordinate system. The display 500 includes reference straight lines such as lines 506, 508, 510. The reference straight lines are preferably positioned at regular intervals. Anomalies such as anomalies 520, 522, 524 are represented by dots in the visual display. The X axis 502 preferably comprises a scaled representation in a cartesian coordinate system of angular data from a polar coordinate system. The Y axis 504 preferably comprises a scaled representation in a cartesian coordinate system of radius data from a polar coordinate system. When displayed in the manner shown in visual display 500, an operator can quickly recognize anomalies that are in very salient sinusoidal or wave patterns 530, 532, 534 in the cartesian visual display. These same anomalies appear as difficult-to-recognize small deviations from round in a polar coordinate system. The transformation makes the patterns easily recognizable to an operator.

No rotation, reorientation, rescaling or mirror imaging of the polar anomaly image is able to provide the visual recognition benefits that are achieved by the transformation of polar to cartesian coordinates shown in FIGS. 4-5.

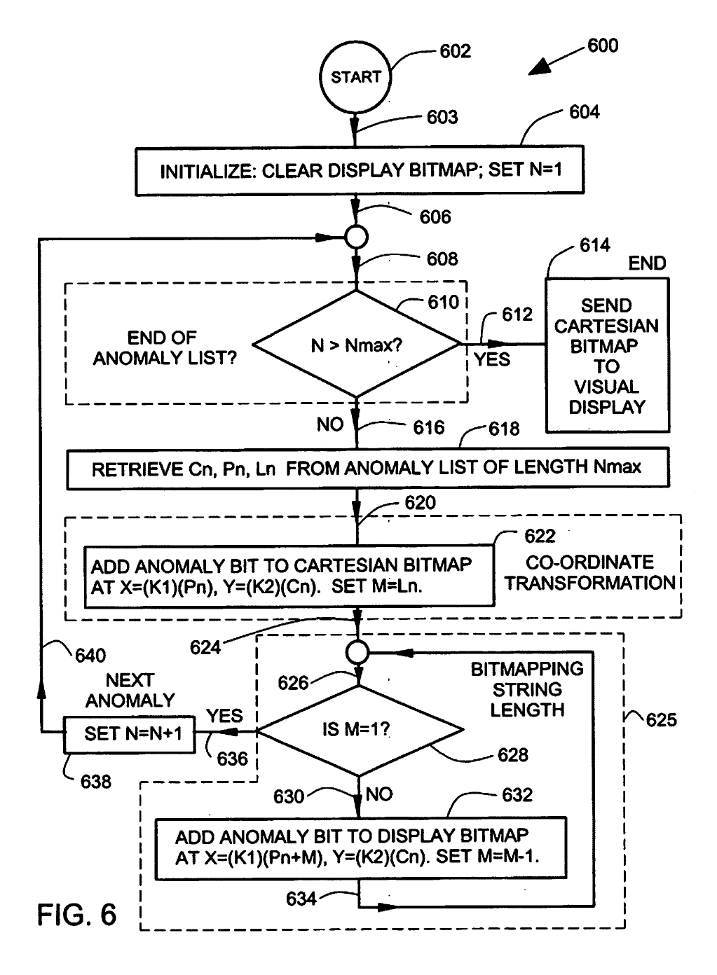

FIG. 6 illustrates an embodiment of a method 600 of visual display transformation that can be used in the processor 420 shown in FIG. 4. The method 600 starts at start 602 and program flow proceeds along line 603 to an initialization process 604. The initialization process 604 comprises clearing the display bitmap of any anomalies and setting an anomaly table index N=1.

After initialization process 604 is complete, program flow continues along lines 606, 608 to decision block 610. At decision block 610, the anomaly table index N is tested to see if it greater than Nmax, the length of the anomaly table. Decision block 610 tests whether the end of the anomaly list has been passed. If the end of the anomaly list has been passed at decision block 610, then program flow proceeds along line 612 to send the completed cartesian bitmap to a visual display at action block 614, which ends program flow. If the end of the anomaly list has not been reached at decision block 610, then program flow proceeds along line 616 to action block 618.

At action block 618, data Cn, Pn, Ln for the current anomaly table index N is retrieved so that it is available for transformation. The data Cn, Pn comprises radius and angle representations of locations of anomalies on a surface. After action block 618 is complete, program flow continues along line 620 to action block 622.

At action block 622, the data Cn, Pn from the anomaly table is transformed to a cartesian anomaly point on a cartesian bitmap. In a preferred embodiment, the transformation is a function of the equations X=(K1)(Pn), Y=(K2)(Cn). In a further preferred embodiment, the string length Ln is included in the anomaly table. Radius representation is transformed to a cartesian coordinate Y, and angle representation is transformed to a cartesian coordinate X. At action block 622, the string mapping index M is set to Ln. After completion of action block 622, program flow continues along line 624 to a routine 625 which bitmaps the string length in cartesian coordinates.

At routine 625, program flow from line 624 proceeds along line 626 to a decision block 628. At decision block 628 the string mapping index M is tested to see if it is equal to one. If M does not equal 1, then program flow proceeds along line 630 to action block 632. At action block 632, an additional anomaly bit is added to the string as a function of the equations X=(K1)(Pn+M), Y=(K2)(Cn). Next, M is incremented by setting M=M+1 and then program flow continues along line 634 and line 626 to the decision block 628. Routine 625 keeps looping through the string length until it is completely bitmapped in the cartesian coordinates. When the string is completely bitmapped, then M=1 at decision block 628, and program flow continues along line 636 to action block 638.

At action block 638, the anomaly table index N is increased by one so that it points to the next entry in the anomaly table. After action block 638 is complete, then program flow continues along line 640 and 608 to decision block 610. Process 600 keeps looping through decision block 610 until all Nmax anomaly entries have been bitmapped into the cartesian coordinate system, then program flow proceeds along line 612 to display the bitmap at 614 and complete the process 600. Anomalies are displayed in a cartesian bitmap of the cartesian coordinates X, Y in a portion of a visual display.

The main anomaly transforming comprises X=(K1)(Pn), Y=(K2)(Cn) where X,Y comprise cartesian coordinates, Cn comprises a cylinder number, Pn comprises a position number, and K1, K2 comprise display scaling factors.

Strings of anomalies are optionally transformed according to X=(K1)(Pn+M), Y=(K2, Cn) where M comprises an index that is incremented over a string length.

In summary, a visual display system (such as 400) comprises a buffer (such as 402) that receives and stores first coordinates (such as 404) of locations of anomalies on a surface. Some of the locations can occur in out-of-round patterns (such as 406) including deviations (such as 407) from a circle (such as 408). A processor (such as 420) receives the first coordinates from the buffer and transforms the first coordinates to second coordinates (XY). The deviations from round in the first coordinates are transformed to deviations (such as 430) from straight lines (such as 432) in the second coordinates. A visual display unit (such as 440) couples to the processor. The visual display unit generates a visual display (such as 442) of the second coordinates in a cartesian bitmap portion of the visual display.

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the visual system while maintaining substantially the same functionality without departing from the scope and spirit of the present invention. In addition, although the preferred embodiment described herein is directed to a defect mapping system for a disc drive system, it will be appreciated by those skilled in the art that the teachings of the present invention can be applied to polar scanning using radar, sonar, tomography, x-rays, magnetics and optics in a wide range of applications, without departing from the scope of the present invention.

1. A visual display system, comprising:
a buffer that receives and stores first coordinates of locations of anomalies on a surface;
a processor that receives the first coordinates from the buffer and that transforms the first coordinates to second coordinates such that deviations from round in the first coordinates are transformed to deviations from straight lines in the second coordinates; and
a visual display unit coupled to the processor and generating a visual display of the second coordinates in a cartesian bitmap.

2. The visual display system of claim 1 wherein the deviations from round are transformed into waves along the straight lines in the cartesian bitmap.

3. The visual display system of claim 1 wherein the anomalies comprise tomographic anomalies.

4. The visual display system of claim 1 wherein the anomalies comprise radar anomalies.

5. The visual display system of claim 1 wherein the anomalies comprise sonar anomalies.

6. The visual display system of claim 1 wherein the anomalies comprise magnetic anomalies.

7. The visual display system of claim 1 wherein the anomalies comprise optic anomalies.

8. The visual display system of claim 1 wherein the anomalies comprise defects on a storage media surface.

9. The visual display system of claim 8 wherein the storage media surface comprises magnetic media.

10. The visual display system of claim 8 wherein the storage media surface comprises optical media.

11. The visual display system of claim 1 wherein the first coordinates comprise cylinder numbers and position numbers.

12. The visual display system of claims 11 wherein the first coordinates further comprise string lengths.

13. The visual display system of claim 1 wherein the processor comprises a cartesian display bitmap generator.

14. The visual display system of claim 1 wherein the processor further generates reference straight lines in the cartesian bitmap portion of the visual display.

15. A visual display transformation method, comprising:
retrieving first coordinates comprising radius and angle representations of locations of anomalies on a surface;
transforming the radius representation to a cartesian coordinate Y and transforming the angle representation to a cartesian coordinate X; and
displaying the anomalies in a cartesian bitmap of the X and Y cartesian coordinates in a portion of a visual display.

16. The visual display transformation method of claim 15 further comprising representing defects on a storage media surface as the anomalies.

17. The visual display transformation method of claim 16 wherein the storage media surface comprises magnetic media.

18. The visual display transformation method of claim 16 wherein the storage media surface comprises optical media.

19. The visual display transformation method of claim 15 wherein the first coordinates comprise cylinder numbers and position numbers.

20. The visual display transformation method of claims 19 wherein the first coordinates further comprise string lengths.

21. The visual display transformation method of claim 15 wherein the visual display unit further displays reference straight lines in the cartesian bitmap portion of the visual display.

22. The visual display transformation method of claim 15 wherein the transforming comprises X=(K1)(Pn), Y=(K2)(Cn) where X,Y comprise cartesian coordinates, Cn comprises a cylinder number, Pn comprises a position number, and K1, K2 comprise display scaling factors.

23. The visual display transformation method of claim 22 wherein the transforming further comprises transforming string lengths according to X=(K1)(Pn+M), Y=(K2, Cn) where M comprises an index that is incremented over a string length.

24. A visual display system, comprising:
a buffer that receives and stores first coordinates of locations of anomalies on a surface; and a visual display unit generating a visual display of the anomalies in a cartesian bitmap portion of the visual display; and
processor means for receiving the first coordinates from the buffer and for transforming the first coordinates to second coordinates in the cartesian bitmap such that deviations from round in the first coordinates are transformed to deviations from straight lines in the second coordinates.

25. The visual display system of claim 24 wherein the anomalies comprise defects on a magnetic media surface.

26. The visual display system of claim 24 wherein the anomalies comprise anomalies selected from the group of tomographic, radar, sonar and optic anomalies.
